(19) United States
(12) Patent Application Publication
(10) Pub. No.: US 2016/0110999 A1
(43) Pub. Date: Apr. 21, 2016

(54) METHODS AND SYSTEMS FOR PARKING MONITORING WITH VEHICLE IDENTIFICATION

(71) Applicant: XEROX CORPORATION, NORWALK, CT (US)

(72) Inventors: Orhan Bulan, Rochester, NY (US); Edgar A. Bernal, Webster, NY (US); Yao Rong Wang, Webster, NY (US); Robert P. Loce, Webster, NY (US)

(21) Appl. No.: 14/515,127

(22) Filed: Oct. 15, 2014

(51) Int. Cl. G08G 1/017; G06K 9/00; H04N 7/18; G06K 9/32

(52) U.S. Cl. CPC G08G 1/0175; G06K 9/325; G06K 9/00664; H04N 7/183; G06K 9/00771; H04N 7/188

(57) ABSTRACT

A system and method for monitoring parking and identifying vehicles by monitoring a parking region based on video data of the parking region received from a video camera, detecting a parking event associated with a vehicle in the parking region, adjusting a view of the video camera based on the parking event, physically tracking the vehicle using the video camera, capturing an image of a license plate of the vehicle, and resuming monitoring the parking region after capturing the image of the license plate.

### TECHNICAL FIELD

The present disclosure relates generally to methods, systems, and computer-readable media for identifying vehicles in monitored parking regions.

### BACKGROUND

Determining and providing real-time parking occupancy data can effectively reduce fuel consumption and traffic congestion, while allowing area authorities to efficiently monitor and detect parking violations and provide automated parking payment options.

Current systems can identify vehicle license plate text using Automatic License Plate Recognition (ALPR) and other systems can identify real-time parking occupancy. However, combining APLR systems with real-time parking occupancy systems creates certain difficulties because ideal camera view angles and zoom ratios that are efficient for parking monitoring may not be efficient for performing APLR. For example, a camera positioned to monitor on-street parking occupancy may not be able to efficiently identify license plate information of parked vehicles because the license plate information is occluded by other parked vehicles. Alternately, a camera positioned to perform APLR may be positioned so as to capture traffic entering or leaving a certain parking region and may not be positioned to effectively monitor parking spaces.

Using multiple cameras where one camera monitors parking spaces and another camera captures license plate information may allow for both methods to be performed, but the cost of providing multiple cameras to cover a given parking region does not escalate efficiently, and installation and maintenance costs could make such a system impractical in certain situations.

Therefore, parking monitoring systems can be improved by methods and systems that can monitor parking and identify vehicles using a single camera.

### SUMMARY

The present disclosure relates generally to methods, systems, and computer-readable media for providing these and other improvements to parking monitoring systems.

In some embodiments, a computing device can monitor a parking region based on video data of the parking region received from a video camera. While monitoring the parking region, the computing device can detect a parking event associated with a vehicle in the parking region. In response to detecting the parking event, the computing device can adjust the view of the video camera to physically track the vehicle using the video camera. While physically tracking the vehicle, the video camera can capture an image of the license plate of the vehicle and then resume monitoring the parking region.

In some embodiments, the video camera can be a pan-tilt-zoom camera and, in further embodiments, the view of the pan-tilt-zoom camera can remain stationary until a parking event is detected.

In some implementations, the computing device can soft track the vehicle before detecting the parking event, where the computing device tracks the vehicle without adjusting the view of the video camera.

In further implementations, the computing device can determine license plate text of the license plate based on the image of the license plate, determine a confidence score of the license plate text, and determine that the confidence score does not meet a predetermined threshold. Based on the determination that the confidence score does not meet the predetermined threshold, a second image can be captured of the license plate.

The computing device can determine the license plate text of the license plate of the vehicle based on the second image of the license plate, determine a confidence score of the license plate text, and determine that the confidence score meets a predetermined threshold. The computing device can then resume monitoring the parking region in response to determining the confidence score meets the predetermined threshold.

In some embodiments, the computing device can determine the location of parking zones within the parking region using the video data. The parking event can be detected when the vehicle enters or exits the parking region.

In further embodiments, the parking zones can be associated with optimal viewing angles and/or optimal zoom ratios, and the view of the video camera can be adjusted to achieve the optimal viewing angles or the optimal zoom ratios.

In other embodiments, detecting the parking event associated with the vehicle in the parking region can be performed via motion analysis. Motion analysis can include detecting a coherent cluster of motion vectors within the parking zone. Alternatively, motion within the parking region can be detected via temporal frame differencing, whereby pixel-wise differences between temporally adjacent frames in the video are computed and the result thresholded and possibly filtered via morphological operations. The resulting binary image may be combined with other binary masks resulting from the processing of different sets of frames via pixel-wise logical operations. The result of the motion detection process is a binary image with pixel dimensions equal to the dimensions of the incoming video, and where ON pixels are associated with image regions in motion, and OFF pixels are associated with stationary image regions.

In still further embodiments, detecting the parking event associated with the vehicle in the parking region can include detecting the vehicle entering or leaving a parking zone using a background subtraction method.

In still further embodiments, detecting the parking event associated with the vehicle in the parking region can include performing a sliding-window search in a given video frame using a vehicle detection classifier trained offline.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1A is a diagram depicting an exemplary video camera arrangement for identifying vehicles and monitoring parking occupancy in a parking region, consistent with certain disclosed embodiments;

FIG. 1B is a diagram depicting an exemplary video camera arrangement for identifying vehicles and monitoring parking occupancy in a parking region, consistent with certain disclosed embodiments;

FIG. 1C is a diagram depicting an exemplary video camera arrangement for identifying vehicles and monitoring parking occupancy in a parking region, consistent with certain disclosed embodiments;

FIG. 1D is a diagram depicting an exemplary video camera arrangement for identifying vehicles and monitoring parking occupancy in a parking region, consistent with certain disclosed embodiments;

FIG. 2A is a diagram depicting an exemplary image captured by a system that can identify vehicles and monitor parking occupancy in a parking region using a single camera, consistent with certain disclosed embodiments;

FIG. 2B is a diagram depicting an exemplary image captured by a system that can identify vehicles and monitor parking occupancy in a parking region using a single camera, consistent with certain disclosed embodiments;

FIG. 2C is a diagram depicting an exemplary image captured by a system that can identify vehicles and monitor parking occupancy in a parking region using a single camera, consistent with certain disclosed embodiments;

FIG. 2D is a diagram depicting an exemplary image captured by a system that can identify vehicles and monitor parking occupancy in a parking region using a single camera, consistent with certain disclosed embodiments;

FIG. 2E is a diagram depicting an exemplary image captured by a system that can identify vehicles and monitor parking occupancy in a parking region using a single camera, consistent with certain disclosed embodiments;

FIG. 3 is a flow diagram illustrating an exemplary method of monitoring a parking region and capturing images of license plates using a single camera, consistent with certain disclosed embodiments;

FIG. 4 is a flow diagram illustrating an exemplary method of tracking vehicles in a parking region to identify license plate text, consistent with certain disclosed embodiments; and

FIG. 5 is a diagram illustrating an exemplary hardware system for identifying vehicles and monitoring parking occupancy in a parking region, consistent with certain disclosed embodiments.

### DETAILED DESCRIPTION

The following detailed description refers to the accompanying drawings. Wherever possible, the same reference numbers are used in the drawings and the following description refers to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

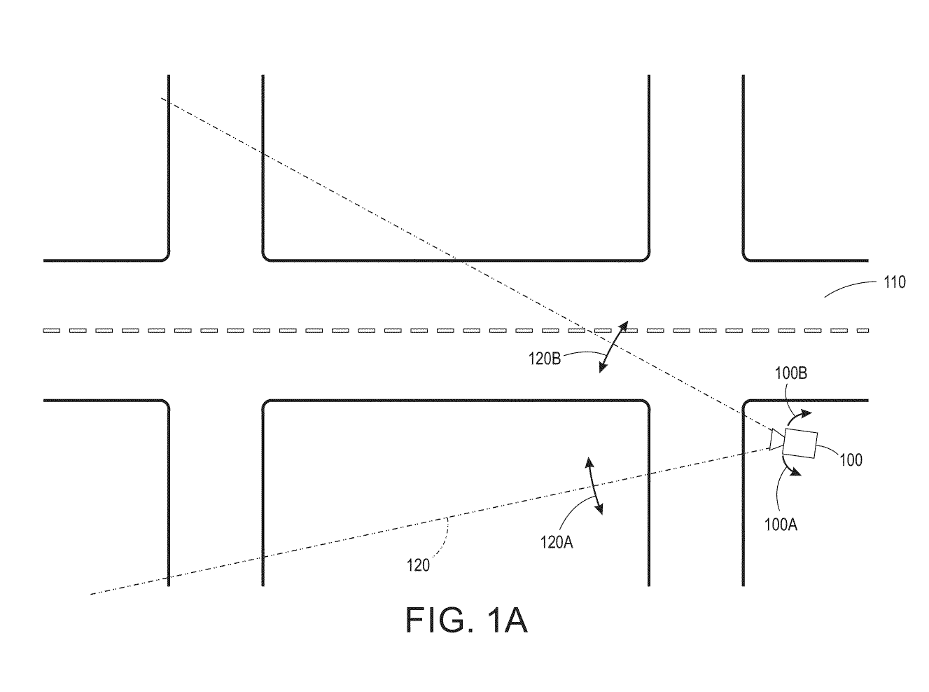

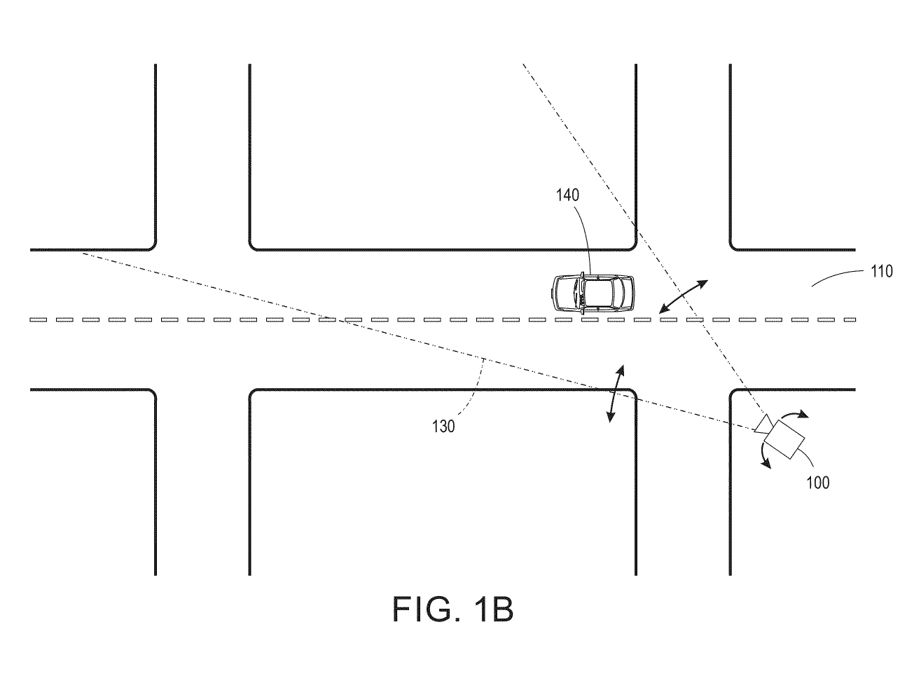

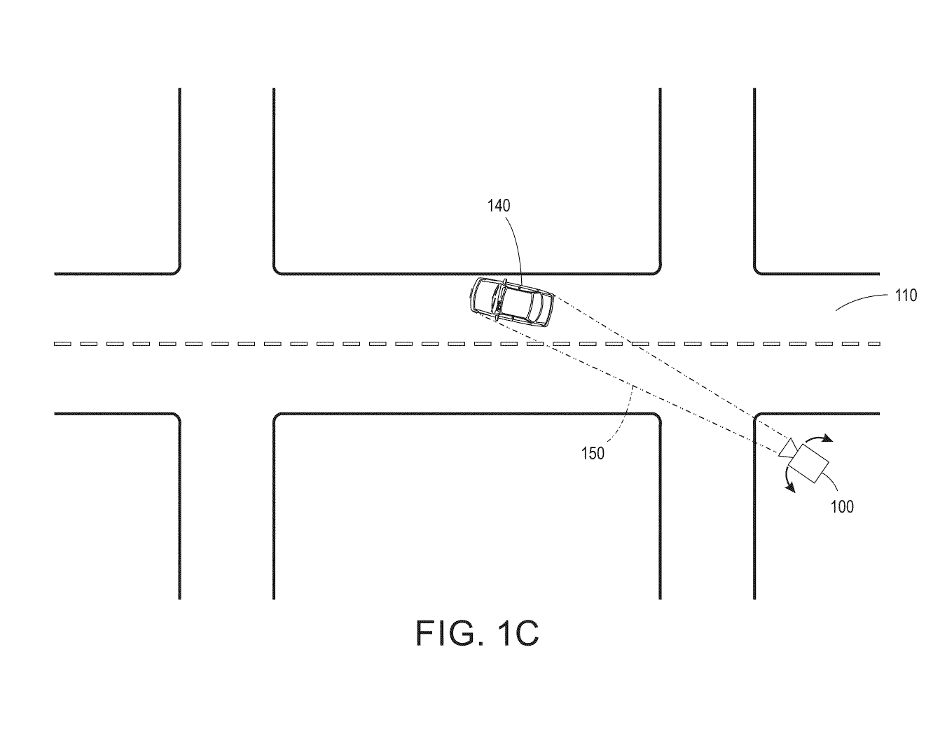

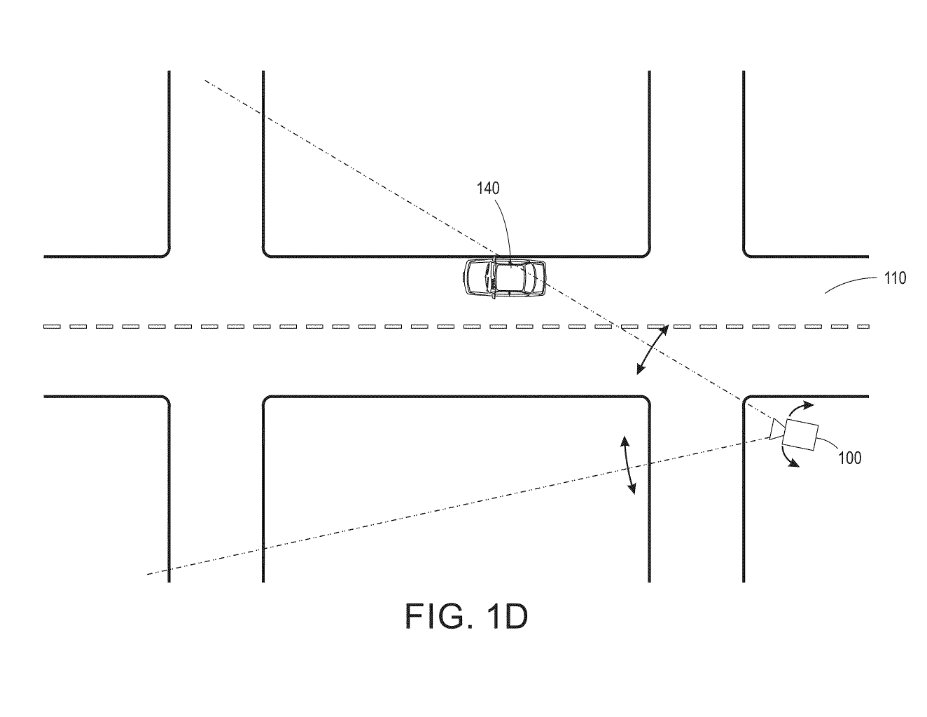

FIG. 1A is a diagram depicting an exemplary video camera arrangement for identifying vehicles and monitoring parking occupancy in a parking region, consistent with certain disclosed embodiments. FIG. 1A is intended merely for the purpose of illustration and is not intended to be limiting.

As depicted in FIG. 1A, video camera 100 can be positioned to record video and/or capture images of a particular parking region. As used herein, a captured image and capturing an image may refer to capturing one or more frames of a video.

In some embodiments, video camera 100 can represent a device that includes a video camera and a computing device. In other embodiments, video camera 100 can be connected to a computing device directly or via one or more network connections.

In this example, the parking region monitored by the video camera can be a parking region corresponding to a city block along street 110. In other embodiments, monitored parking regions can be larger or smaller than a city block, and disclosed embodiments are not limited to street parking.

Camera view 120 can represent a current view of camera 100, and can show that video camera 100 is monitoring parking on street 110. In some embodiments, camera 100 may be capable of changing its current view in order to more effectively monitor parking and identify vehicles in the parking region. Such movement is represented in FIG. 1A by arrows 100A and 100B (movement of camera 100) and by arrows 120A and 120B (movement of and/or change in the current view of camera 100). For example, camera 100 can be a pan-tilt-zoom camera (PTZ camera).

As further depicted in FIG. 1A, no vehicles are currently parked on street 110. In some embodiments, camera 100 may adjust its view by panning, tilting, and/or zooming while monitoring the empty parking region in order to monitor a larger area. In other embodiments, camera 100 may remain stationary until a parking event occurs and is detected.

FIG. 1B is a diagram depicting an exemplary video camera arrangement for identifying vehicles and monitoring parking occupancy in a parking region, consistent with certain disclosed embodiments. FIG. 1B is intended merely for the purpose of illustration and is not intended to be limiting.

As depicted in FIG. 1B, video camera 100 may have panned horizontally while recording video and/or capturing images of the parking region corresponding to the city block along street 110. In some embodiments, video camera 100 may adjust its view while monitoring the parking region in order to monitor a larger area. In other embodiments, video camera may not move or adjust its view until a parking event occurs.

Camera view 130 can represent a view subsequent to camera view 120 in FIG. 1A of camera 100, and can show that video camera 100 is monitoring parking on street 110.

As further depicted in FIG. 1B, vehicle 140 is on street 110 and has entered camera view 130. Vehicle 140 may not trigger detection of a parking event because vehicle 140 is currently moving on street 110 in a driving lane and has not exhibited any indications of attempting to park on street 110 and/or has not entered a parking zone. In some embodiments, camera 100 may not track vehicle 140 in any way because a parking event was not detected. In other embodiments, camera 100 may track vehicle 140 without changing the camera view or changing the movement of camera 100 (hereinafter, “soft tracking”). In other words, if camera 100 pans, tilts, and/or zooms while monitoring the parking region, it will continue to do so normally. If camera 100 remains stationary and does not adjust its view while monitoring the parking region, it will continue to remain stationary.

Soft tracking consists of determining the location, in pixels, of an object or vehicle within a sequence of frames. Soft tracking can be performed by the computing device using, for example, a Kanade-Lucas-Tomasi (KLT) feature tracker approach, a mean shift tracking approach, a particle filter tracking approach, and the like.

FIG. 1C is a diagram depicting an exemplary video camera arrangement for identifying vehicles and monitoring parking occupancy in a parking region, consistent with certain disclosed embodiments. FIG. 1C is intended merely for the purpose of illustration and is not intended to be limiting.

As depicted in FIG. 1C, vehicle 140 may have triggered detection of a parking event by moving towards the curb along street 110. Methods for detecting parking events are discussed in greater detail below.

As a result of the detected parking event, video camera 100 may have zoomed in to get a tighter view on the rear of vehicle 140 so that video camera 100 can better capture an image of the license plate of vehicle 140. Camera view 150 can represent the zoomed-in camera view of camera 100. In some embodiments, video camera 100 may also pan and/or tilt in response to the detected parking event as is appropriate to better capture the image of the license plate.

In further embodiments, video camera 100 can attempt to capture other identifiers instead of or in addition to a license plate. For example, identifiers may include stickers, decals, rear window hangers, unique vehicle features, etc. Video camera 100 may adjust its view as is appropriate to better capture the images of such identifiers.

FIG. 1D is a diagram depicting an exemplary video camera arrangement for identifying vehicles and monitoring parking occupancy in a parking region, consistent with certain disclosed embodiments. FIG. 1D is intended merely for the purpose of illustration and is not intended to be limiting.

As depicted in FIG. 1D, after capturing an image of the license plate of vehicle 140, video camera 100 may resume regular monitoring of the parking region. For example, video camera 100 may pan, tilt, and/or zoom to a monitoring position and may restart normal pan, tilt, and zoom motions during monitoring, if applicable.

In some embodiments, video camera 100 may resume regular monitoring immediately after capturing the image of license plate of vehicle 140. In other embodiments, video camera 100 may capture multiple images of the license plate and each image can be analyzed to determine if ALPR can be performed and/or if a threshold confidence score of the license plate text is achieved during ALPR. If ALPR cannot be performed on the image and/or a threshold confidence score is not achieved, the video camera can capture another image of the license plate. If ALPR can be performed on the image and/or a threshold confidence score is achieved, the video camera can resume normal monitoring.

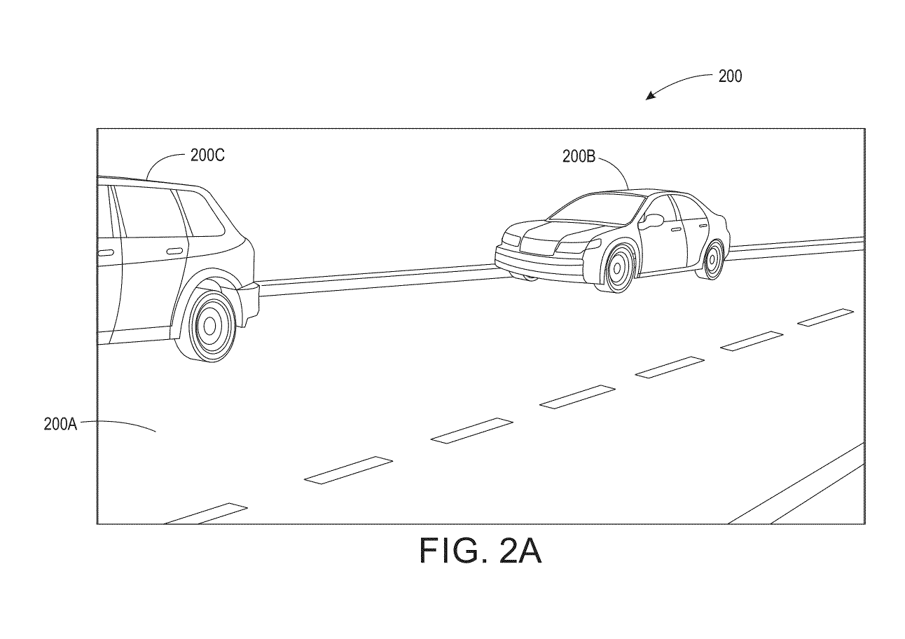

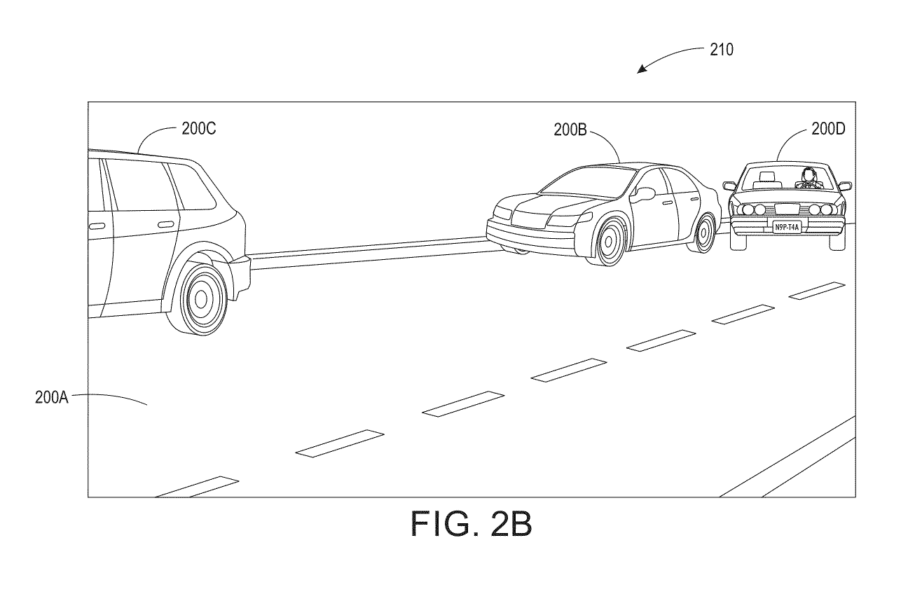

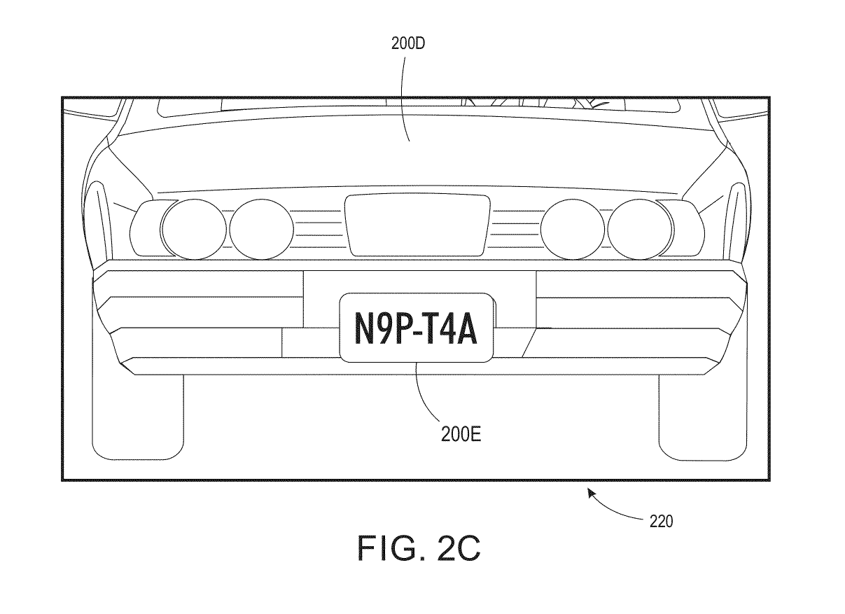

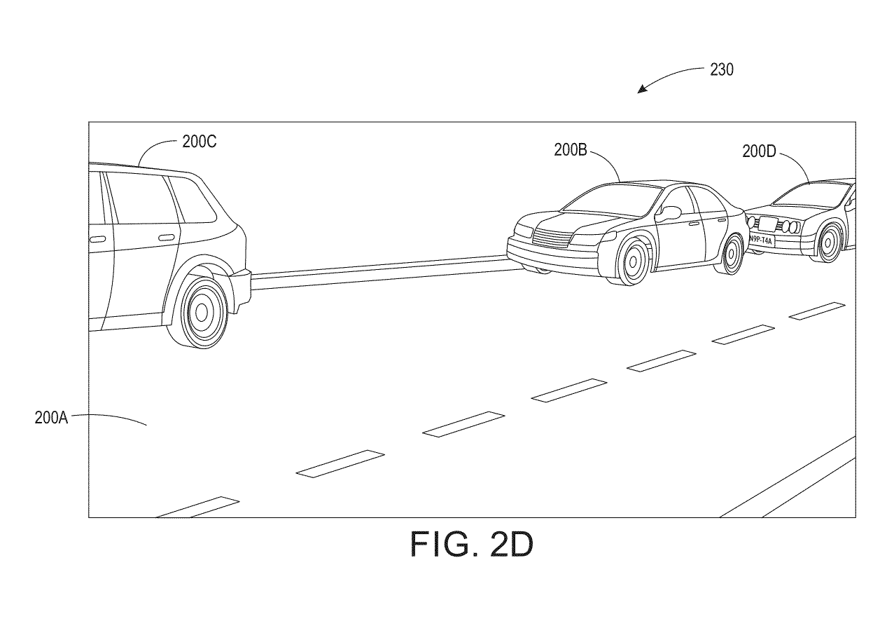

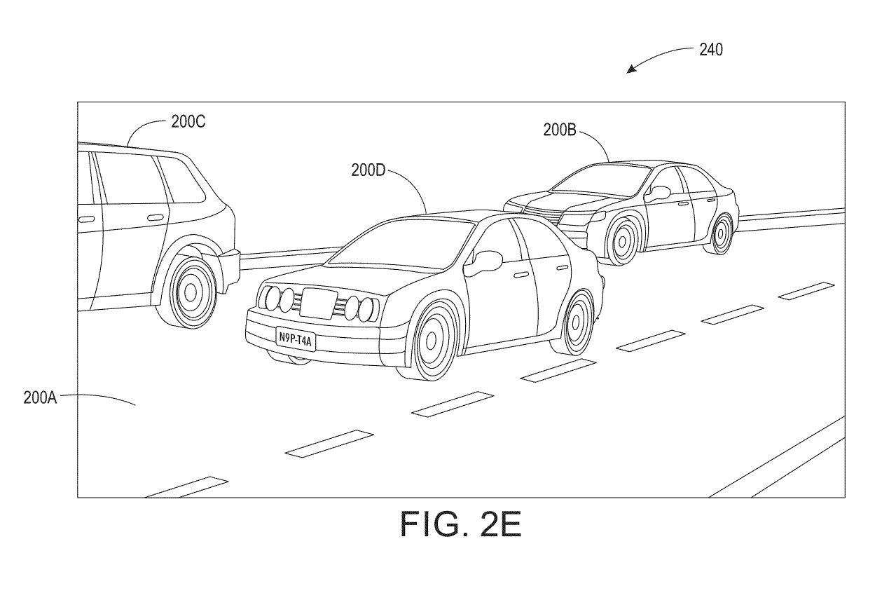

FIG. 2A is a diagram depicting an exemplary image captured by a system that can identify vehicles and monitor parking occupancy in a parking region using a single camera, consistent with certain disclosed embodiments. FIG. 2A is intended merely for the purpose of illustration and is not intended to be limiting.

A video camera positioned to record video and/or capture images of a particular parking region may have captured image 200. Captured image 200 may be transferred to a computing device as, for example, a streaming video file.

In this example, the parking region monitored by the video camera can be a parking region corresponding to a city block along street 200A. In other embodiments, monitored parking regions can be larger or smaller than a city block, and disclosed embodiments are not limited to street parking.

As depicted in image 200, vehicles 200B and 200C are currently parked on street 200A.

Image 200 may represent an image captured by a video camera that is performing normal monitoring of the parking region. In other words, because no vehicle is currently parking or leaving a parking spot, a parking event has not been triggered and the video camera has not adjusted its view (i.e., panned, tilted, and/or zoomed) to capture a license plate.

FIG. 2B is a diagram depicting an exemplary image captured by a system that can identify vehicles and monitor parking occupancy in a parking region using a single camera, consistent with certain disclosed embodiments. FIG. 2B is intended merely for the purpose of illustration and is not intended to be limiting.

The video camera positioned to record video and/or capture images of the parking region may have captured image 210. Captured image 210 may be transferred to the computing device as, for example, a streaming video file.

As depicted in image 210, vehicles 200B and 200C are currently parked on street 200A. Additionally, vehicle 200D is backing into a parking space behind vehicle 200B. Vehicle 200B may have triggered a parking event.

Image 210 may represent an image captured by a video camera that is performing normal monitoring of the parking region immediately before a parking event is triggered by vehicle 200B.

FIG. 2C is a diagram depicting an exemplary image captured by a system that can identify vehicles and monitor parking occupancy in a parking region using a single camera, consistent with certain disclosed embodiments. FIG. 2C is intended merely for the purpose of illustration and is not intended to be limiting.

The video camera positioned to record video and/or capture images of the parking region may have zoomed in to better capture an image of license plate 200E of vehicle 200D and captured image 220. The video camera may have zoomed in response to the parking event depicted in FIG. 2C. Captured image 220 may be transferred to the computing device as, for example, a streaming video file.

As depicted in image 220, license plate 200E is clearly visible and, accordingly, an ALPR process performed on image 220 may yield license plate text with a high confidence score.

FIG. 2D is a diagram depicting an exemplary image captured by a system that can identify vehicles and monitor parking occupancy in a parking region using a single camera, consistent with certain disclosed embodiments. FIG. 2D is intended merely for the purpose of illustration and is not intended to be limiting.

The video camera positioned to record video and/or capture images of the parking region may have captured image 230. Captured image 230 may be transferred to the computing device as, for example, a streaming video file.

As depicted in image 230, vehicles 200B, 200C, and 200D are currently parked on street 200A.

Image 230 may represent an image captured by a video camera upon resuming normal monitoring after the parking event that was depicted in images 210 and 220. The normal monitoring may have resumed immediately after image 220 was captured or may have resumed after an ALPR process was performed on image 220 and license plate text was determined with a confidence score that exceeded a threshold.

Notably, in image 230, the license plate of vehicle 200D is occluded by vehicle 200B. Accordingly, a video camera capturing images with such a camera view would be unable to capture an image of the license plate of vehicle 200D at this time.

FIG. 2E is a diagram depicting an exemplary image captured by a system that can identify vehicles and monitor parking occupancy in a parking region using a single camera, consistent with certain disclosed embodiments. FIG. 2E is intended merely for the purpose of illustration and is not intended to be limiting.

The video camera positioned to record video and/or capture images of the parking region may have captured image 240. Captured image 240 may be transferred to a computing device as, for example, a streaming video file.

As depicted in image 240, vehicles 200B and 200C are currently parked on street 200A. Additionally, vehicle 200D is leaving the parking space behind vehicle 200B. In some embodiments, vehicle 200D may have triggered a parking event, while, in further embodiments, vehicle 200D may not have triggered a parking event because an image of the license plate of vehicle 200D has already been captured and processed.

Image 240 may represent an image captured by a video camera immediately before a parking event is triggered by vehicle 200D and that is performing normal monitoring of the parking region.

Notably, in image 240, license plate 200E of vehicle 200D is not occluded by vehicle 200B. Accordingly, a video camera capturing images with such a camera view would be able to capture an image of license plate 200E of vehicle 200D at this time if necessary to identify vehicle 200D.

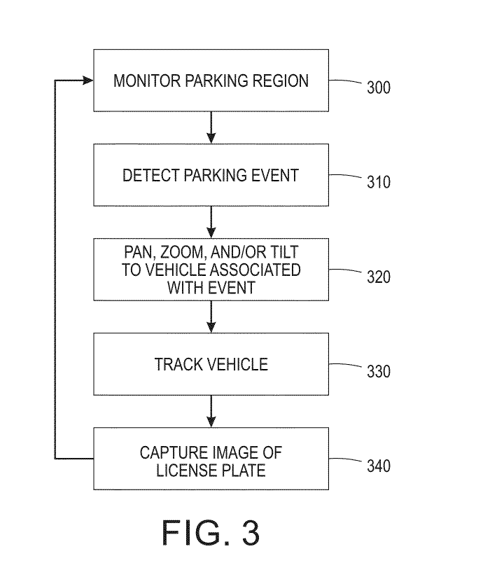

FIG. 3 is a flow diagram illustrating an exemplary method of monitoring a parking region and capturing images of license plates using a single camera, consistent with certain disclosed embodiments. The process can begin in 300 when a computing device receives video data from a video camera. In some embodiments, the video data can be a streaming video feed from the video camera. In further embodiments, the video data can be one or more recorded videos and/or one or more captured images from the video camera.

In some implementations, the video data can represent captured video of a parking region. The computing device can process and analyze the video to monitor the parking region. For example, the computing device can process and analyze the video in real time using streaming video from the video camera.

In further embodiments, the video camera can be strategically positioned to capture various perspectives of the parking region. For example, the video camera can be a PTZ camera and its view can be adjusted while monitoring to create a wider viewing area and/or avoid occlusion factors.

In embodiments, the video data can be from multiple video cameras monitoring multiple sections of the parking region and/or multiple parking regions. The video data can be processed as a whole or for each video camera individually.

In further embodiments, the computing device can provide frame rate and resolution parameters to the video camera based on requirements of parking occupancy detection and ALPR systems. For example, 5 frames per second and a resolution of 640×480 pixels may be sufficient for parking occupancy detection. Higher resolution may be required for ALPR systems. Other parameters, such as activating Near-Infrared (NIR) capabilities of certain video cameras, may also be provided, for example, to monitor a parking region at night.

In 310, based on the video data, the computing device can detect an occurrence of a parking event. Examples of a parking event can include, but are not limited to, a vehicle entering a parking space, a vehicle leaving a parking space, a vehicle in a previously unoccupied parking space, and an empty parking space that was previously occupied.

In some embodiments, the computing device can determine the location of parking zones within the parking region. For example, each legal parking space and each illegal parking space (e.g., adjacent to a fire hydrant) can be a determined parking zone. Additionally, the computing device can determine coordinates associated with an optimal viewing angle for each parking zone. The optimal viewing angle can be, for example, a viewing angle that provides an unoccluded view of a likely location of a license plate of a vehicle parking in or leaving a parking space. Note that viewing angle refers to an orientation of the optical axis of the camera relative to the parking region. In a pan-tilt-zoom camera, a viewing angle can be adjusted by panning or tilting the camera or by physically displacing the camera. Further, in some implementations, the computing device can determine an optimum zoom ratio for each parking zone. The optimum zoom ratio can be, for example, a zoom ratio that allows for optimum focus on the likely location of a license plate of a vehicle parking in or leaving a parking space.

In further embodiments, the computing device can monitor each of the parking zones throughout the video data. In some embodiments, when a vehicle is detected entering or leaving a parking zone, an occurrence of a parking event can be detected. In other embodiments, an occurrence of a parking event can be detected when a moving vehicle enters a parking zone and becomes stationary, or when a stationary vehicle begins moving and leaves a parking zone, these detections being done based, for example, on soft tracking data of the vehicle. Specifically, as vehicle coordinates are detected to enter the parking zone and become stationary, detection of a moving vehicle entering a parking zone can be performed. Similarly, as vehicle coordinates of a previously stationary vehicle within the parking zone move and leave the parking zone, detection of a previously stationary vehicle leaving the parking zone can be performed.

In some embodiments, the computing device can detect a vehicle entering or leaving a parking zone by performing motion analysis. In one embodiment, motion analysis is performed by calculating motion vectors from the video data. The motion vectors can be compression-type motion vectors obtained by using a block-matching algorithm. Alternatively, motion vectors can be calculated by using an optical flow method. The computing device can then detect a coherent cluster of motion vectors within a parking zone, potentially indicating a vehicle entering or leaving a parking zone. Alternatively, motion within the parking region can be detected via temporal frame differencing, whereby pixel-wise differences between temporally adjacent frames in the video are computed and the result thresholded and possibly filtered via morphological operations. The resulting binary image may be combined with other binary masks resulting from the processing of different sets of frames via pixel-wise logical operations. The result of the motion detection process is a binary image with pixel dimensions equal to the dimensions of the incoming video, and where ON pixels are associated with image regions in motion, and OFF pixels are associated with stationary image regions. A binary blob in or around a parking zone potentially indicates a vehicle entering or leaving the parking zone.

In other embodiments, the computing device can detect a vehicle entering or leaving a parking zone by using a background subtraction method where background estimation is performed for a single reference location and configuration of the PTZ camera (i.e., a specific pan, tilt, and zoom combination that ideally gives a good view of the monitored scene). Different background models can be constructed for different configurations of the PTZ camera. Background estimation can be based on Gaussian mixture models, eigen-backgrounds which use principal component analysis, and/or computing of running averages that gradually update the background as new frames are acquired.

For example, the first time a foreground blob is detected in a parking zone may indicate a vehicle entering the parking zone. Similarly, a foreground blob, previously stationary, now in motion can indicate a vehicle leaving the parking zone. In some embodiments, the detected foreground regions, indicating a vehicle entering or leaving a parking zone, can be validated using a vehicle detection classifier that is trained offline. In some implementations, the computing device can perform a sliding-window search of a video frame using the vehicle detection classifier. The classifier can be trained by extracting several vehicle attributes/features from the vehicles in the parking zone.

In further embodiments, the computing device can detect an occurrence of a parking event when a vehicle in a previously unoccupied parking space is detected and/or when an empty parking space that was previously occupied is detected. For example, in an embodiment where the video camera pans, tilts, and/or zooms while monitoring a parking region, a vehicle may park in a parking zone that is outside the video camera's field of view while the vehicle is parking. When the video camera pans, tilts, and/or zooms while monitoring and captures an image and/or video that includes the vehicle in the previously unoccupied parking zone, the computing device can detect an occurrence of a parking event.

In 320, the computing device can instruct the video camera to adjust its view (i.e., pan, tilt, and/or zoom) to better capture the vehicle associated with the parking event. In some embodiments, the video camera can pan and/or tilt based on the coordinates associated with an optimal viewing angle for the parking zone that triggered the parking event. Additionally or alternatively, the video camera can zoom based on the optimum zoom ratio for the parking zone that triggered the parking event. In further embodiments, the video camera can adjust its view based on, for example, a pixel location of movement that is detected.

Adjusting the view of the video camera in 320 may allow the video camera to better lock onto the vehicle and identify a position of a license plate of the vehicle for physically tracking the vehicle.

In 330, the computing device can track the vehicle that triggered the parking event. As the vehicle gets further away from the camera center, the computing device can instruct the video camera to adjust the pan and/or tilt accordingly to “physically track” the vehicle from the video. As used herein, “physically tracking” a vehicle can refer to a process of tracking a vehicle on the computing device by altering the zoom ratio and/or view of the camera for the purpose of tracking, so that a possibly moving vehicle and its identifiable attributes remain in view.

Alternatively, the computing device can soft track the vehicle from the video after adjusting its view in 320.

In some embodiments, the computing device can instruct the video camera to further adjust its view to better capture a license plate of the vehicle. For example, the computing device can instruct the video camera to further zoom in on a license plate.

In 340, while tracking the vehicle, the video camera can capture an image of the license plate of the vehicle. In some embodiments, the video camera may simply capture an image representing the likely position of the license plate based on the angle of the vehicle, occlusion factors, and the parking zone. Once the image is captured, the video camera can return to normal monitoring of the parking region in 300. For example, the video camera may return to the zoom ratio used for normal monitoring, may pan and tilt to the position used for normal monitoring, and/or may restart the process of panning, tilting, and/or zooming during normal monitoring to capture a wider area.

The computing device may perform ALPR on the image that is captured to determine license plate text, may store the image for later processing, and/or may transmit the image for remote processing. Any license plate text that is determined can be used to detect parking violations, allow for automatic parking payments, determine the amount of time that a vehicle is parked, etc.

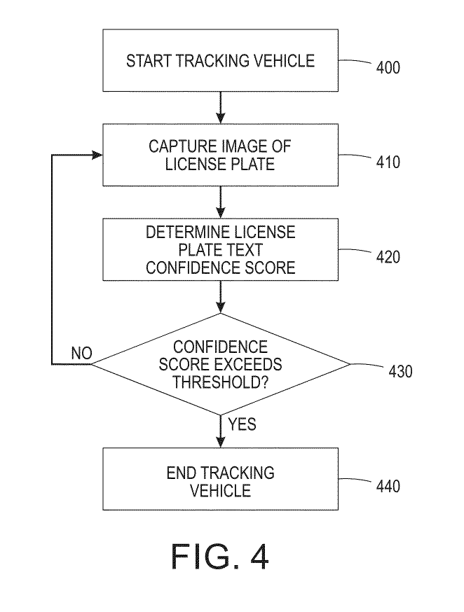

In other embodiments, the video camera may capture images representing the likely position of the license plate and/or based on instructions from the computing device until an image of the license plate is captured, ALPR is performed, and a sufficient confidence score of the ALPR result is achieved, as discussed with regard to FIG. 4.

While the steps depicted in FIG. 3 have been described as performed in a particular order, the order described is merely exemplary, and various different sequences of steps can be performed, consistent with certain disclosed embodiments. Additional variations of steps can be utilized, consistent with certain disclosed embodiments. Further, the steps described are not intended to be exhaustive or absolute, and various steps can be inserted or removed.

For example, in some embodiments, the video camera may soft track moving and parked vehicles within its view while monitoring the parking region using instructions from the computing device. Once the moving vehicle begins to park or the parked vehicle begins to move, the video camera can switch from soft tracking the vehicle to physically tracking the vehicle.

As an additional example, a parking event may not be triggered if a vehicle already triggered a parking event (e.g., a vehicle that had previously parked) and an image of the license plate of the vehicle had already been captured. The computing device may soft track the vehicle until it leaves and/or may disregard parking events associated with the parking zone until the vehicle leaves the parking zone.

FIG. 4 is a flow diagram illustrating an exemplary method of tracking vehicles in a parking region to identify license plate text, consistent with certain disclosed embodiments. The process described with regard to FIG. 4 can represent an embodiment and/or variation of the process described with regard to FIG. 3.

The process can begin in 400 after the computing device has detected a parking event and adjusted its view based on the vehicle associated with the event (e.g., 310 and 320 in FIG. 3). In 400, the computing device can start tracking the vehicle (e.g., 330 in FIG. 3) and, in 410, capture an image of the license plate of the vehicle (e.g., 340 in FIG. 3).

In 420, the computing device can perform ALPR on the image to determine any license plate text that is present in the image. If no license plate text is present in the image, the computing device can instruct the video camera to provide additional images, can instruct the video camera to adjust its view based on the predicted location of the license plate, and/or can receive additional images from the video camera.

If license plate text is present, ALPR can be performed, license plate text can be determined, and a confidence score can be assigned to the license plate text. If the confidence score does not exceed a threshold (430, NO), then the process can proceed to 410, and the computing device can instruct the video camera to provide additional images, can instruct the video camera to adjust its view based on the predicted location of the license plate, and/or can receive additional images from the video camera.

If the confidence score does exceed or meet a threshold (430, YES), then the process can proceed to 440, where the computing device ends the process of tracking the vehicle. The computing device can then return to normal monitoring (e.g., 300 in FIG. 3).

The computing device may store the image and/or the determine license plate text. In some embodiments, the computing device may transmit the image and/or the determined license plate text to a remote location. Any license plate text that is determined can be used to detect parking violations, allow for automatic parking payments, determine the amount of time that a vehicle is parked, etc.

In some embodiments, if a threshold confidence score is not achieved after a predetermined number of attempts, the computing device determines that the vehicle is no longer moving, the computing device determines that the vehicle is no longer within the view of the video camera, and/or the computing device otherwise determines that an acceptable image cannot be achieved, the computing device can return to normal monitoring. The computing device may, in certain implementations, store one or more of the images that were captured or store the image that achieved the highest confidence score. Additionally or alternatively, a parked vehicle can be soft tracked until it leaves the parking space and another attempt at determining the license plate text can be performed. In further embodiments, an exiting vehicle can be matched to a vehicle that previously had parked and the license plate text determined while the vehicle was parking can be used.

While the steps depicted in FIG. 4 have been described as performed in a particular order, the order described is merely exemplary, and various different sequences of steps can be performed, consistent with certain disclosed embodiments. Additional variations of steps can be utilized, consistent with certain disclosed embodiments. Further, the steps described are not intended to be exhaustive or absolute, and various steps can be inserted or removed.

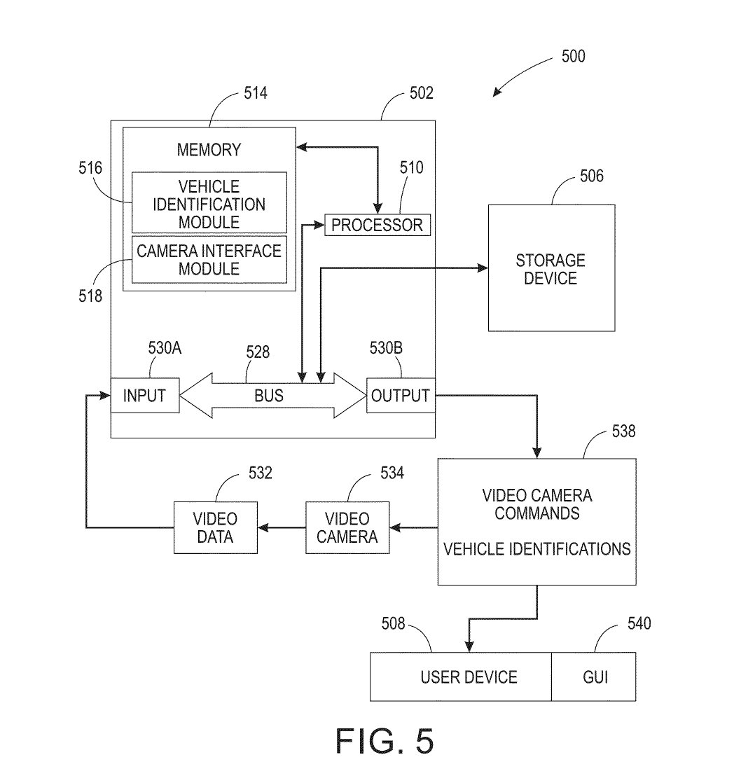

FIG. 5 is a diagram illustrating an exemplary hardware system for identifying vehicles and monitoring parking occupancy in a parking region, consistent with certain disclosed embodiments. The system 500 includes a vehicle identification device 502, a video camera 534, and a storage device 506, which may part of the same device or may be linked together by communication links (i.e. a network). In one embodiment, the system 500 may further include a user device 508. In some embodiments, vehicle identification device 502 and user device 508 may be part of the same device, while, in further embodiments, vehicle identification device 500 and user device 508 may be linked together by a communication links. These components are described in greater detail below.

The vehicle identification device 502 illustrated in FIG. 5 includes a controller that is part of or associated with the vehicle identification device 502. The exemplary controller is adapted for controlling an analysis of video data received by the system 500. The controller includes a processor 510, which controls the overall operation of the vehicle identification device 502 by execution of processing instructions that are stored in memory 514 connected to the processor 510.

The memory 514 may represent any type of tangible computer readable medium such as random access memory (RAM), read only memory (ROM), magnetic disk or tape, optical disk, flash memory, or holographic memory. In one embodiment, the memory 514 includes a combination of random access memory and read only memory. The processor 510 can be variously embodied, such as by a single core processor, a dual core processor (or more generally by a multiple core processor), a digital processor and cooperating math coprocessor, a digital controller, or the like. The digital processor, in addition to controlling the operation of the vehicle identification device 502, executes instructions stored in the memory 514 for performing the parts of methods discussed herein. In some embodiments, the processor 510 and the memory 514 may be combined in a single chip.

The vehicle identification and monitoring processes disclosed herein are performed by the processor 510 according to the instructions contained in the memory 514. In particular, the memory 514 stores a vehicle identification module 516, which, for example, monitors parking regions, detects parking events, and tracks and identifies vehicles; and a camera interface module 518, which provides instructions to and receives video data 532 from the video camera 534. Embodiments are contemplated wherein these instructions can be stored in a single module or as multiple modules embodied in the different devices.

The software modules as used herein, are intended to encompass any collection or set of instructions executable by the vehicle identification device 502 or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server (not shown) or other location to perform certain functions. The various components of the vehicle identification device 502 may be all connected by a bus 528.

With continued reference to FIG. 5, the vehicle identification device 502 also includes one or more communication interfaces (e.g., an input 530A and an output 530B), such as network interfaces, for communicating with external devices and/or between internal processes. The communication interfaces may include, for example, user input devices, a display, a modem, a router, a cable, and and/or Ethernet port, etc. The communication interfaces are adapted to receive video data as input (e.g., the video data 532).

The vehicle identification device 502 may include one or more special purpose or general purpose computing devices, such as a server computer or any other computing device capable of executing instructions for performing the exemplary method.

FIG. 5 further illustrates the vehicle identification device 502 connected to the video camera 534 for inputting commands and/or receiving the video data and/or image data (herein collectively referred to as “video data”) in electronic format. The video camera 534 may include an image capture device, such as a camera. The video camera 534 can include one or more surveillance cameras that capture video data from the parking region. For performing the method at night in areas without external sources of illumination, the video camera 534 can include near infrared (NIR) capabilities at the low-end portion of a near-infrared spectrum (700 nm-1000 nm).

In one embodiment, the video camera 534 can be a device adapted to relay and/or transmit the video captured by the camera to the vehicle identification device 502. For example, the video camera 534 can include a scanner, a computer, or the like. In another embodiment, the video data 532 may be input from any suitable source, such as a workstation, a database, a memory storage device, such as a disk, or the like. The video camera 534 is in communication with the controller containing the processor 510 and memory 514.

With continued reference to FIG. 5, the system 500 includes a storage device 506 that is part of or in communication with the vehicle identification device 502. In a contemplated embodiment, the vehicle identification device 502 can be in communication with a server (not shown) that includes a processing device and memory, such as the storage device 506.

With continued reference to FIG. 5, the video data 532 undergoes processing by the vehicle identification device 502 to output vehicle identification and video camera command output 538, which can include, for example, video camera commands and vehicle identifications. Such output 538 (e.g., vehicle identifications) can be provided to the user device 508 and presented via, for example, a graphic user interface (GUI) 540.

The GUI 540 can include a display, for displaying information, such as vehicle identifications, video data, etc., and a user input device, such as a keyboard or touch or writable screen, for receiving instructions as input, and/or a cursor control device, such as a mouse, trackball, or the like, for communicating user input information and command selections to the processor 510.

While the teachings has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method comprising:
monitoring a parking region based on video data of a view of the parking region received from a video camera;
detecting, using a processor, a parking event associated with a vehicle in the parking region;
physically tracking the vehicle by adjusting a view of the video camera;
capturing an image of a license plate of the vehicle; and
subsequent to capturing the image of the license plate, resuming monitoring the parking region by physically adjusting the view of the video camera.

2. The method of claim 1, wherein the video camera is a pan-tilt-zoom camera.

3. The method of claim 1, wherein the view of the video camera remains stationary until a parking event is detected.

4. The method of claim 1, further comprising soft tracking the vehicle before detecting the parking event.

5. The method of claim 1, further comprising:
determining license plate text of the license plate of the vehicle based on the image of the license plate;
determining a confidence score of the license plate text;
determining that the confidence score does not meet a predetermined threshold;
capturing a second image of the license plate of the vehicle, wherein monitoring the parking region is resumed by physically adjusting the view of the video camera subsequent to capturing the second image.

6. The method of claim 5, further comprising:
determining license plate text of the license plate of the vehicle based on the second image of the license plate;
determining a confidence score of the license plate text;
determining that the confidence score meets a predetermined threshold, wherein monitoring the parking region is resumed by physically adjusting the view of the video camera in response to determining that the confidence score meets the predetermined threshold.

7. The method of claim 1, further comprising determining a location of a parking zone within the parking region, wherein the parking event is detected using the location of the parking zone.

8. The method of claim 7, wherein:
the parking zone is associated with at least one of an optimal viewing angle and an optimal zoom ratio; and
adjusting the view of the video camera comprises adjusting the view to achieve the at least one of an optimal viewing angle and an optimal zoom ratio.

9. The method of claim 1, wherein detecting the parking event associated with the vehicle in the parking region comprises at least one of:
detecting the vehicle entering the parking zone and detecting the vehicle change from moving to stationary; or
detecting the vehicle leaving the parking zone and detecting the vehicle change from stationary to moving.

10. The method of claim 9, wherein detecting the vehicle change from moving to stationary or detecting the vehicle change from stationary to moving comprises analyzing motion within the parking zone.

11. The method of claim 9, wherein detecting the vehicle change from moving to stationary or detecting the vehicle change from stationary to moving comprises detecting the vehicle entering or leaving a parking zone using tracking information of the vehicle.

12. A system comprising:
a video camera;
a processing system comprising one or more processors capable of receiving data from the video camera; and
a memory system comprising one or more computer-readable media, wherein the one or more computer-readable media contain instructions that, when executed by the processing system, cause the processing system to perform operations comprising:
monitoring a parking region based on video data of a view of the parking region received from the video camera;
detecting a parking event associated with a vehicle in the parking region;
physically tracking the vehicle by adjusting a view of the video camera;
capturing an image of a license plate of the vehicle; and
subsequent to capturing the image of the license plate, resuming monitoring the parking region by physically adjusting the view of the video camera.

13. The system of claim 12, wherein the video camera is a pan-tilt-zoom camera.

14. The system of claim 12, wherein the view of the video camera remains stationary until a parking event is detected.

15. The system of claim 12, the operations further comprising soft tracking the vehicle before detecting the parking event.

16. The system of claim 12, the operations further comprising:
determining license plate text of the license plate of the vehicle based on the image of the license plate;
determining a confidence score of the license plate text;
determining that the confidence score does not meet a predetermined threshold;
capturing a second image of the license plate of the vehicle, wherein monitoring the parking region is resumed by physically adjusting the view of the video camera subsequent to capturing the second image.

17. The system of claim 16, the operations further comprising:
determining license plate text of the license plate of the vehicle based on the second image of the license plate;
determining a confidence score of the license plate text;
determining that the confidence score meets a predetermined threshold, wherein monitoring the parking region is resumed by physically adjusting the view of the video camera in response to determining that the confidence score meets the predetermined threshold.

18. The system of claim 12, the operations further comprising determining a location of a parking zone within the parking region, wherein the parking event is detected using the location of the parking zone.

19. The system of claim 18, wherein:
the parking zone is associated with at least one of an optimal viewing angle and an optimal zoom ratio; and
adjusting the view of the video camera comprises adjusting the view to achieve the at least one of an optimal viewing angle and an optimal zoom ratio.

20. The system of claim 12, wherein detecting the parking event associated with the vehicle in the parking region comprises at least one of:
detecting the vehicle entering the parking zone and detecting the vehicle change from moving to stationary; or
detecting the vehicle leaving the parking zone and detecting the vehicle change from stationary to moving.

21. The system of claim 20, wherein detecting the vehicle change from moving to stationary or detecting the vehicle change from stationary to moving comprises analyzing motion within the parking zone.

22. The system of claim 20, wherein detecting the vehicle change from moving to stationary or detecting the vehicle change from stationary to moving comprises detecting the vehicle entering or leaving a parking zone using tracking information of the vehicle.
